(19) United States
(12) Patent Application Publication
(10) Pub. No.: US 2020/0131335 A1
(43) Pub. Date: Apr. 30, 2020

(54) SURFACE ACTIVE ADJUVANT

(71) Applicant: RHODIA OPERATIONS, Paris (FR)

(72) Inventor: Tomoaki TSURUMI, Tokyo (JP)

(21) Appl. No.: 16/605,595

(22) PCT Filed: Apr. 19, 2018
(86) PCT No.: PCT/EP2018/059972

§ 371 Date: Oct. 16, 2019

(30) Foreign Application Priority Data
Apr. 19, 2017 (EP) PCT/EP2017/059280

(51) Int. Cl. C08K 5/20; C08K 5/06

(52) U.S. Cl. CPC C08K 5/20; C08K 5/06

(57) ABSTRACT

The present invention relates to an adjuvant comprising an amide compound and a non-ionic surfactant. The present invention further relates to an aqueous composition comprising said adjuvant and a latex polymer.

### CROSS-REFERENCE TO RELATED APPLICATIONS

The present application claims priority to International Application No. PCT/EP2017/059280 filed on 19 Apr. 2017, the whole content of both applications being incorporated herein by reference.

Should the disclosure of any patents, patent applications, and publications which are incorporated herein by reference conflict with the description of the present application to the extent that it may render a term unclear, the present description shall take precedence.

### TECHNICAL FIELD

The present invention relates to an adjuvant, notably a surface active adjuvant. The present invention also relates to an aqueous composition which comprises a latex polymer and the said adjuvant.

### BACKGROUND ART

Surfactants are widely used in waterborne formulations, such as waterborne coatings. Modern surfactants often have properties that are specifically tailored to the performance requirements of the particular application in which they are used.

Some industrial processes that utilize surfactants involve dynamic surface conditions in which the speed of new surface creation is high, for instance in applications such as printing, rolling coating, curtain coating, ink jetting, spraying coating, etc. Such processes typically require that surfactants included in the applied formulation exhibit the ability to lower the surface tension efficiently, to wet the substrate rapidly, to facilitate the emulsification and/or dispersing, and so on. Dynamic surface tension (DST) is generally used to measure the capability of one solution to lower surface tension.

For example, U.S. Pat. No. 5,328,884 discloses a color developer composition which contains an amide compound as emulsifier/dispersant.

Polar organic solvents are also known to be useful for reducing surface tension of waterborne formulations. However, use of organic solvents has certain drawbacks, such as high VOC (Volatile Organic Compound) content in the resulting formulations.

There is a need to provide new surfactant systems which are highly potent in reducing surface tension of aqueous compositions, such as aqueous coating compositions. There is a need to provide new surfactant systems which can, at low dosages, effectively reduce surface tension of the aqueous compositions. There is a need to provide new surfactant systems which can lead to low surface tension combined with good miscibility when the surfactant systems are formulated into waterborne formulations. There is a need to provide aqueous coating compositions which have low surface tensions and the associated benefits.

### SUMMARY OF INVENTION

In one aspect, the present invention provides an adjuvant, notably a surface active adjuvant, comprising (A) an amide compound and (B) a non-ionic surfactant;

wherein the amide compound is represented by the general formula:

R₁—(C═O)—N(R₂)(R₃) (I)

wherein R₁ represents C₄-C₂₂, saturated or unsaturated, linear or branched, aliphatic hydrocarbon group; and

R₂ and R₃ independently represent hydrogen, or a C₁-C₄, saturated or unsaturated, linear or branched, aliphatic hydrocarbon group; the non-ionic surfactant has an HLB value in the range of from 13 to 18.

In some embodiments, the amide compound is represented by the general formula:

R₁—(C═O)—N(R₂)(R₃) (II)

wherein R₁ represents a C₄-C₂₂, saturated or unsaturated, linear or branched, aliphatic hydrocarbon group; and

R₂ and R₃ are methyl.

In some embodiments, the non-ionic surfactant is a compound represented by the general formula:

R₆—(OCH₂CH₂)ₙ—OH (III)

wherein R₆ is a C₈-C₁₄ alkyl, preferably a C₁₁-C₁₄ alkyl;

n is an integer of from 5 to 100, preferably from 5 to 50, even more preferably from 8 to 40.

In another aspect of the present invention, there is provided an aqueous composition, notably an aqueous coating composition, comprising the said adjuvant and a latex polymer. The adjuvant, when being formulated into the aqueous composition, can effectively and rapidly reduce surface tension. The aqueous composition can provide good miscibility as well. It has also been found that the aqueous compositions incorporating the adjuvant have low surface tension, which would help the compositions to spread out at the interphase, leading to benefits, such as fast wetting, good cleaning, dispersion and emulsification, subject to the application for which the aqueous composition is used.

The aqueous composition may further comprise a pigment.

The aqueous compositions may be used for coatings, such as binders, paints, inks, adhesives, The polymer may include, but is not limited to: water based all-acrylic copolymer, styrene-acrylic copolymer, vinyl acetate-acrylic copolymer, vinyl acetate-ethylene copolymer, polyvinyl acetate, polyvinyl acrylate, alkyd, epoxy, and polyurethane dispersion. Other similar polymers can also be used.

### DETAILED DESCRIPTION

Throughout the description, including the claims, the term “comprising one” or “comprising a” should be understood as being synonymous with the term “comprising at least one”, unless otherwise specified, and “between” should be understood as being inclusive of the limits.

It should be noted that in specifying any range of concentration, weight ratio or amount, any particular upper concentration, weight ratio or amount can be associated with any particular lower concentration, weight ratio or amount, respectively.

The articles “a”, “an” and “the” are used to refer to one or to more than one (i.e., to at least one) of the grammatical object of the article.

The term “and/or” includes the meanings “and”, “or” and also all the other possible combinations of the elements connected to this term.

As used herein, the terminology “(Cₙ-Cₘ)” in reference to an organic group, wherein n and m are each integers, indicates that the group may contain from n carbon atoms to m carbon atoms per group.

As used herein, the term “hydrocarbon group” refers to a group mainly consisting of carbon atoms and hydrogen atoms, which group may be saturated or unsaturated, linear, branched or cyclic, aliphatic or aromatic.

As used herein, “aliphatic hydrocarbon group” refers to a straight or branched hydrocarbon chain, and optionally containing one to two sites of olefinic unsaturation or one or two sites of acetylenic unsaturation, such as alkyl and alkenyl.

“Alkyl”, as used herein, means a group or part of a group which refers to a straight or branched saturated aliphatic hydrocarbon group. Examples of suitable alkyl include methyl, ethyl, n-propyl, 2-propyl, n-butyl, sec-butyl, t-butyl, hexyl, and the like.

Amide Compound

The amide compound according to the present invention is represented by the general formula:

R₁—(C═O)—N(R₂)(R₃) (I)

wherein R₁ represents C₄-C₂₂, saturated or unsaturated, linear or branched, aliphatic hydrocarbon group; and

R₂ and R₃ independently represent hydrogen, or a C₁-04, saturated or unsaturated, linear or branched, aliphatic hydrocarbon group.

In general formula (I), R₁ is preferably a C₄-C₂₀ aliphatic group, more preferably a C₅-C₁₆ aliphatic hydrocarbon group, even more preferably a C₆-C₁₂ aliphatic hydrocarbon group, and most preferably a C₈-C₁₀ aliphatic hydrocarbon group.

In particular, the amide compound is represented by the general formula:

R₁—(C═O)—N(R₂)(R₃) (II)

wherein R₁ represents a C₄-C₂₂, saturated or unsaturated, linear or branched, aliphatic hydrocarbon group; and

R₂ and R₃ are methyl.

In general formula (II), R₁ is preferably a C₅-C₁₆ aliphatic hydrocarbon group, more preferably a C₆-C₁₂ aliphatic hydrocarbon group, even more preferably a C₈-C₁₀ aliphatic hydrocarbon group.

Examples of the amide compound include and are not limited to N,N-di(2-ethylhexyl)formamide, N,N-dicyclohexylformamide, N,N-diphenylformamide, N,N-dibutylacetamide, N,N-dioctylacetamide, N,N-di(2-ethylhexyl)acetamide, N-[3-(2-ethylhexyloxy)propyl]acetamide, N,N-dicyclohexylacetamide, N,N-diphenylacetamide, N,N-dibenzylacetamide, N,N-di(2-ethylhexyl)propionamide, N,N-dicyclohexylpropionamide, N,N-diethylcaprylamide, N,N-dibutylcaprylamide, N,N-di(2-ethylhexyl)caprylamide, N,N-dicyclohexylcaprylamide, N,N-dimethyllauroylamide, N,N-diethyllauroylamide, N,N-dibutyllauroylamide, N-(2-ethyl hexyl)lauroylamide, N,N-di(2-ethylhexyl)lauroylamide, N-lauryllauroylamide, N,N-diallyllauroylamide, N,N-dicyclohexyllauroylamide, N,N-dimethylmyristoylamide, N,N-diethylmyristoylamide, palmitoylamide, N,N-dimethylpalmitoylamide, N,N-diethylpalmitoylamide, stearoylamide, N,N-dimethylstearoylamide, N,N-diethylstearoylamide, oleoylamide, N,N-dimethyloleoylamide, N,N-diethyloleoylamide, N,N-dibutyloleoylamide, N,N-dibutylphenoxyacetamide, N,N-di(2-ethylhexyl)phenoxyacetamide, N,N-d ibutylbenzoylamide, N,N-di(2-ethylhexyl)benzoylamide, N,N-dibutylphenylacetamide, N,N-di(2-ethylhexyl)phenylacetamide, N,N-di(2-ethylhexyl)cyclohexamide, N,N-diethylbenzamide, lauroylmorpholide, caprylmorpholide, oleoylmorpholide, N,N-di(2-ethylhexyl)acetamide, N,N-dicyclohexylacetamide, N,N-diethyllauroylamide, N,N-dibutyllauroylamide, N,N-dimethyloleoylamide, N,N-diethyloleoylamide and N,N-dibutyloleoylamide, N,N-dioctylmethanesulfonamide, N,N-dicyclohexylmethanesulfonamide, N,N-dioctylethanesulfonamide, benzenesulfonamide, N-methylbenzenesulfonamide, N,N-dimethylbenzenesulfonamide, N-ethylbenzenesulfonamide, N,N-diethylbenzenesulfonamide, N-butylbenzenesulfonamide, N,N-dibutylbenzenesulfonamide, N-octylbenzenesulfonamide, N,N-dioctylbenzenesulfonamide, N-dodecylbenzenesulfonamide, N,N-dicyclohexylbenzenesulfonamide, toluenesulfonamide, N-methyltoluenesulfonamide, N,N-dimethyltoluenesulfonamide, N-ethyltoluenesulfonamide, N,N-diethyltoluenesulfonamide, N-butyltoluenesulfonamide, N,N-dibutyltoluenesulfonamide, N-octyltoluenesulfonamide, N,N-dioctyltoluenesulfonamide, N-dodecyltoluenesulfonamide, N-(2-hydroxyethyl)toluenesulfonamide, N-(3-methoxypropyl)toluenesulfonamide, N-(3-ethoxypropyl)toluenesulfonamide, N-(3-octoxypropyl)toluenesulfonamide, N-(toluenesulfonyl)morpholine, N-(benzenesulfonyl)piperidine, xylenesulfonamide, N,N-dimethylxylenesulfonamide, N,N-diethylxylenesulfonamide, N,N-dibutylxylenesulfonamide, N-octylxylenesulfonamide, chlorobenzenesulfonamide, N,N-diethylchlorobenzenesulfonamide, N,N-dibutylchlorobenzene-sulfonamide, N,N-dimethylbiphenylsulfonamide, N,N-diethyl-biphenylsulfonamide, N,N-dibutyltoluenesulfonamide, N,N-dioctylbenzenesulfonamide, N,N-dioctylmethanesulfonamide, N-octylxylenesulfonamide, N,N-dimethyl hexamide, N,N-dimethyl octanamide, N,N-dimethyl decanamide, N,N-dimethyl dodecanamide, N,N-dimethyl decamide, N,N-dimethyl tetradecanamide, and the like.

Non-Ionic Surfactant

The non-ionic surfactant according to the present invention has an HLB (Hydrophile-Lipophile Balance) value in the range of from 13 to 18. HLB value of non-ionic surfactants can typically be determined according to the GRIFFIN Method which is well known to a person skilled in the art. HLB value is calculated by the following formulation:

HLB=(molecular weight of hydrophilic group portion/molecular weight of total surfactant)×100/5

Examples of the non-ionic surfactant include glycerol fatty acid esters, sorbitan fatty acid esters, sucrose fatty acid esters, having a structure in which polyhydroxylic alcohols such as glycerol, sorbitol and sucrose are bonded to fatty acids via ester bond, respectively.

Examples of the non-ionic surfactant also include polyoxyalkylene alkyl ether, polyoxyalkylene alkylphenyl ether or polyoxyethlene/polyoxypropyrene alkyl ether, polyoxyethylene/polyoxypropyrene alkylphenyl ether, and a mixture thereof.

Examples of the non-ionic surfactant further include fatty acid alkanolamide and alkyl polyglucoside.

Examples of the non-ionic surfactant further include polyoxyethylene sorbitan monolaurate, polyoxyethylene sorbitan monopalmitate, polyoxyethylene sorbitan monostearate, polyoxyethylene sorbitan monooleate, polyoxyethylene sorbitan trioleate, and a mixture thereof.

Additional examples of the non-ionic surfactant include those sold under Rhodasurf® BC series products manufactured by the Solvay Company.

Preferably, the non-ionic surfactant is a compound represented by the general formula:

R₄—(OCH₂CH₂)ₙ—OH (III)

wherein R₄ is a C₈-C₁₄ alkyl, preferably a C₁₁-C₁₄ alkyl, such as C₁₁, C₁₂ C₁₃ and C₁₄ alkyl;

n is an integer of from 5 to 100, preferably from 5 to 50, even more preferably from 8 to 40.

Alternatively, in the general formula (III), R₄ is a C₂-C₈ alkyl, n is an integer of from 5 to 100, preferably from 5 to 50, even more preferably from 8 to 40.

One preferred example of the non-ionic surfactant is polyoxyethylene tridecyl ether, notably polyoxyethylene tridecyl ether having an ethoxylation number of from 8 to 40. “Ethoxylation number”, as used herein, means the average number of alkylene oxide or ethylene oxide repeating units contained in the ethoxylated compound.

In some embodiments, the adjuvant comprises (A) an amide compound and (B) an non-ionic surfactant;

wherein the amide compound is represented by the general formula:

R₁—(C═O)—N(R₂)(R₃) (II)

wherein R₁ represents a C₄-C₂₂, saturated or unsaturated, linear or branched, aliphatic hydrocarbon group;

R₂ and R₃ are methyl;

the non-ionic surfactant is a compound represented by the general formula:

R₄—(OCH₂CH₂)ₙ—OH (III)

wherein R₄ is a C₈-C₁₄ alkyl;

n is an integer of from 5 to 100.

In some embodiments, the adjuvant comprises (A) an amide compound and (B) an non-ionic surfactant;

wherein the amide compound is represented by the general formula:

R₁—(C═O)—N(R₂)(R₃) (II)

wherein R₁ represents a C₄-C₂₂, saturated or unsaturated, linear or branched, aliphatic hydrocarbon group;

R₂ and R₃ are methyl;

the non-ionic surfactant is a compound represented by the general formula:

R₄—(OCH₂CH₂)ₙ—OH (III)

wherein R₄ is a C₁₁-C₁₄ alkyl;

n is an integer of from 8 to 40.

In some embodiments, the surfactant composition comprises (A) an amide compound and (B) an non-ionic surfactant;

wherein the amide compound is represented by the general formula:

R₁—(C═O)—N(R₂)(R₃) (II)

wherein R₁ represents a C₆-C₁₂, saturated or unsaturated, linear or branched, aliphatic hydrocarbon group;

R₂ and R₃ are methyl;

the non-ionic surfactant is a compound represented by the general formula:

R₄—(OCH₂CH₂)ₙ—OH (III)

wherein R₄ is a C₁₁-C₁₄ alkyl;

n is an integer of from 8 to 40.

The weight ratio of the amide compound and the non-ionic surfactant is preferably in the range of from 2:3 to 19:1, more preferably in the range of from 3:4 to 15:1.

In another aspect, the present invention relates to an aqueous composition, notably an aqueous coating composition, which comprises the adjuvant described herein. As used herein, the term “ coating composition” includes and is not limited to latex binders, resins, glues, adhesives which include and are not limited to pressure sensitive adhesives, inks which include and are not limited to UV inks, conventional inks, hybrid inks, and water-based inks, sealants, cement compositions, coatings which include and are not limited to paints. In the case of aqueous coating composition, the aqueous composition of the present invention may notably comprise at least one latex polymer derived from at least one acrylic monomer selected from the group consisting of acrylic acid, acrylic acid esters, methacrylic acid, and methacrylic acid esters; at least one pigment and water. The aqueous coating composition may further comprise a filler. As mentioned above, the at least one latex polymer can be a pure acrylic, a styrene acrylic, a vinyl acrylic or an acrylated ethylene vinyl acetate copolymer. The latex polymer may be water based epoxy. The latex polymer may also be water borne alkyd, and polyurethane dispersion. Other similar water borne polymers can also be used.

The adjuvant or the aqueous composition may further comprise water and/or an organic solvent, such as alcohols, formamides, acetamides, glycols, glycolethers, diglymes, glycoletheracetates and ketones. Examples of the organic solvent include: methanol, ethanol, 2-propanol, 1-propanol, butanol, hexanol, 2-ethylhexanol, DMF, DMAC, EG, PG, glycerol, DEG, TEG, hexyleneglycol, alkylcellosolve, alkylcarbitol, PEG monoalkylethers, methylglyme, ethylglyme, ethylenglycolmonomethlyether acetate, acetone, MEK.

The present invention also relates to a process for preparing the adjuvant, wherein the process comprises at least a step of mixing (A) an amide compound, and (B) a non-ionic surfactant as described herein. Optionally, the process may also involve mixing the adjuvant with water and/or an organic solvent as mentioned above. Optionally, the mixing is done with heat, for example, heat to a temperature up to 80° C.

The adjuvant, notably the surface active adjuvant, when formulated into an aqueous composition, can effectively reduce surface tension of the aqueous composition. Typically, the aqueous composition containing the adjuvant, even at a surfactant level of below 0.5 wt % based on the total weight of the aqueous composition, has a dynamic surface tension of no more than 30 mN/m, preferably from 24 to 30 mN/m. Accordingly, the present invention also relates to an aqueous composition having a dynamic surface tension of no more than 30 mN/m, preferably from 24 to 30 mN/m, within a surface age of 0.3 sec. Preferably said aqueous composition comprises (A) an amide compound and (B) a non-ionic surfactant as described herein.

The aqueous composition may be an aqueous solution or dispersion, an oil-in-water emulsion, a water-in-oil emulsion, an oil-water-oil emulsion, a water-oil-water emulsion, an oily solution, an alcoholic solution, and the like.

The present invention also relates to a process for preparing an aqueous composition comprising the step of mixing the adjuvant described herein with water, optionally with the additional ingredients and organic solvents described herein. The mixing can be done by any mean well known to a skilled person.

The total weight of the amide compound and the non-ionic surfactant present in the aqueous composition may be in the range of from 0.01% to 5% based on the total weight of the aqueous composition, preferably from 0.05% to 3%, more preferably from 0.1% to 1%, still more preferably from 0.2% to 0.5%.

The adjuvant and the aqueous composition of the present invention may each further comprise one or more additional surfactants. The additional surfactant may be an anionic surfactant, a cationic surfactant, an amphoteric surfactant or a mixture thereof.

Examples of suitable anionic surfactant include carbonic acid salts, sulfonic acid salts, sulfate ester salts, phosphate ester salts, and the like. Examples of the anionic surfactant include Rhodapex® LA40S (manufactured by the Solvay Company).

Examples of the cationic surfactant include amine salts, such as quaternary ammonium salts.

Examples of the amphoteric surfactant include carbonic acid salt type surfactant and the like. The carbonic acid salt type surfactants may be amino acids or betaines.

The adjuvant and the aqueous composition may each contain further additives, as long as the additives do not inhibit the effect of the present invention. Examples of the additives include polymer, pigment, dye, oil, emulsifier, dispersant, defoamer, coalescent, thickener, anti-static agent, slipping agent, anti-slipping agent, hardener, preservative, UV absorber, antibacterial agent, antistatic agent.

The aqueous composition of the present invention may further comprise a diluent. Examples of the diluent include alcohols, ethers, esters, ketones, aldehydes, aliphatic and aromatic, and cyclic hydrocarbons, naturally occurring flavoring agents, vegetable oils, propylene carbonate, propylene glycol, reduced vinyl pyrrolidone dimer, gamma-butyrolactone, N,N-dimethyl imidazolidone, cyclohexanone and methyl ethyl ketone, benzophenone, benzyl benzoate esters of long chain carboxylic acid with greater than 4 carbon atoms or esters with an alkyl group from the alcohol segment has more than 4 carbon atoms, alcohols having greater than six carbons, or hydrocarbon solvents for those active ingredients having high solubility and with low water solubility. Also suitable as the organic diluent are aromatic petroleum oils including those which are commercially available distillates from crude oils having an average boiling point greater than 200° C. Typical of such materials are those sold under the trademarks Exon 200 or Texaco 400.

The present invention will be explained in greater detail through Examples and Comparative Examples, but the present invention is not to be construed as being limited thereto.

### EXAMPLES

Evaluation of Visual Appearance

Aqueous solutions were respectively prepared according to the formulations shown in Tables 1 and 2 below. The solutions were prepared by mixing the ingredients with distilled water. The solutions were stirred with a magnetic stirrer for 1 hour under 25° C. The visual appearance was then observed. Homogeneous solution indicates good miscibility and occurrence of phase separation indicates poor miscibility. Results are shown in the lower panels of Tables 1 and 2.

Dynamic Surface Tension Measurement

Dynamic surface tension measurement was carried out with bubble pressure tensiometer Krüss BP-50. The steps were conducted according to the manual of the equipment. Typically, the formulations according to Tables 1 and 2 were respectively prepared and stirred for 1 hour at 25° C. Then the formulations were subject to dynamic surface tension measurement at 25° C. Surface tension was measured at surface age (also referred to as “bubble life time”)=0.03 sec, 0.3 sec and 3 sec, respectively. Results are shown in the lower panels of the Tables.

TABLE 1

| | Example | | | | | | |
|---|---|---|---|---|---|---|---|
| | 1 | 2 | 3 | 4 | 5 | 6 | 7 |
| Formulations (wt %) | | | | | | | |
| C₈-C₁₀ dimethtylamide | 0.4 | — | 0.4 | 0.4 | 0.4 | 0.45 | 0.3 |
| decanedimethylamide | — | 0.4 | — | — | — | — | — |
| tridecyl ethoxylate | 0.05 | 0.05 | 0.1 | — | — | 0.03 | 0.1 |
| (HLB 15.4) | | | | | | | |
| tridecyl ethoxylate | — | — | — | 0.1 | — | — | — |
| (HLB 13.8) | | | | | | | |
| tridecyl ethoxylate | — | — | — | | 0.1 | — | — |
| (HLB 18) | | | | | | | |
| lauryl ethoxylate | 0.05 | 0.05 | — | — | — | 0.03 | 0.1 |
| sulfate, sodium salt | | | | | | | |
| water | d.s. | d.s. | d.s. | d.s. | d.s. | d.s. | d.s. |
| Results | | | | | | | |
| Appearance | H | H | H | H | H | H | H |
| ST @0.03 s (mN/m) | 27.5 | 27.4 | 30.4 | 30.7 | 30.1 | 27.2 | 30.9 |
| ST @0.3 s (mN/m) | 24.8 | 24.4 | 26.0 | 26.0 | 25.9 | 24.8 | 26.9 |
| ST @3 s (mN/m) | 24.4 | 24.0 | 24.6 | 24.5 | 24.5 | 24.3 | 25.5 |

TABLE 2

| | Comparative Example | | | | | | |
|---|---|---|---|---|---|---|---|
| | 1 | 2 | 3 | 4 | 5 | 6 | 7 |
| Formulations (wt %) | | | | | | | |
| C₈-C₁₀ | — | — | — | 0.4 | 0.4 | 0.5 | — |
| decanedimethylamide | — | — | — | — | — | — | — |
| 2,4,7,9-tetramethy1-5decyn-4,7- | — | — | — | | | | 0.5 |
| diol | | | | | | | |
| tridecyl ethoxylate (HLB 15.4) | 0.5 | — | 0.25 | — | — | — | — |
| tridecyl ethoxylate (HLB 12.5) | — | — | — | 0.1 | — | — | — |
| tridecyl ethoxylate (HLB 8) | — | — | — | — | 0.1 | — | — |
| lauryl ethoxylate sulfate, sodium | — | 0.5 | 0.25 | — | — | — | — |
| salt | | | | | | | |
| water | d.s. | d.s. | d.s. | d.s. | d.s. | d.s. | d.s. |
| Results | | | | | | | |
| Appearance | H | H | H | P | P | P | P |
| ST @0.03 s (mN/m) | 40.4 | 53.5 | 49.7 | 30.1 | 32.7 | 29.4 | 32.3 |
| ST @0.3 s (mN/m) | 34.0 | 44.2 | 41.5 | 26.0 | 27.3 | 26.1 | 29.7 |
| ST @3 s (mN/m) | 30.4 | 39.5 | 37.6 | 24.9 | 26.4 | 25.1 | 29.0 |

(“H” refers to homogenous and “P” refers to phase separation)

As shown in Table 1, the formulations according to the present invention exhibited low surface tension combined with good miscibility. Also, the surface tension was reduced rapidly, for example, the surface tension was reduced to below 30mN/m and almost reached the equilibrium within a surface age of 0.3 sec.

As shown in Table 2, formulations without the amide compound

(Comparative Examples 1-3) exhibited insufficient reduction in the surface tension. Formulations without the tridecyl ethoxylate having HLB=13-18 (Comparative Examples 4-6) exhibited poor miscibility.

Test in Acrylic Latex

The adjuvant according to the present invention was tested in acrylic latex.

Results are shown in Table 3 below:

TABLE 3

| | E8 | CE8.a | CE8.b |
|---|---|---|---|
| Acrylic Latex (50% solid, | 20 | 20 | 20 |
| Saibinol CA-200) | | | |
| C₈—C₁₀ dimethtylamide | 0.8 | 1.0 | 0.8 |
| tridecyl ethoxylate (HLB 15.4) | 0.2 | — | — |
| tridecyl ethoxylate (HLB 8) | — | — | 0.2 |
| water | d.s. | d.s. | d.s. |
| Appearance | Good | Poor | Poor |
| ST @3s (mN/m) | 37.6 | 38.4 | 37.4 |

(E means Example and CE means Comparative Example)

The inventive composition exhibited low surface tension and good miscibility. The Comparative Examples exhibited poor miscibility and showed coagulum.

Test in StyAcr Ltex

The adjuvant according to the present invention was tested in StyAcr latex. Results are shown in Table 4 below:

TABLE 4

| | E9 | CE9.a | CE9.b |
|---|---|---|---|
| StyAcr latex, 45% solid | 20 | 20 | 20 |
| C₈—C₁₀ dimethtylamide | 0.8 | 1.0 | 0.8 |
| tridecyl ethoxylate (HLB 15.4) | 0.2 | — | — |
| tridecyl ethoxylate (HLB 8) | — | — | 0.2 |
| water | d.s. | d.s. | d.s. |
| Appearance | Good | Poor | Poor |
| ST @3s (mN/m) | 41.0 | 41.7 | 40.0 |

The inventive composition exhibited low surface tension and good miscibility. The Comparative Examples exhibited poor miscibility and showed coagulum.

Test in PU Latex

The adjuvant according to the present invention was tested in PU latex. Results are shown in Table 4 below:

| | E10 | CE10.a | CE10.b |
|---|---|---|---|
| Polyurethane latex (37% solid; | 20 | 20 | 20 |
| Evafanol HA170) | | | |
| C₈—C₁₀ dimethtylamide | 0.8 | 1.0 | 0.8 |
| tridecyl ethoxylate (HLB 15.4) | 0.2 | — | — |
| tridecyl ethoxylate (HLB 8) | — | — | 0.2 |
| water | d.s. | d.s. | d.s. |
| Appearance | Good | Poor | Poor |
| ST @3s (mN/m) | 39.4 | 40.9 | 38.2 |

The inventive composition exhibited low surface tension and good miscibility. The Comparative Examples exhibited poor miscibility and showed coagulum.

1. An aqueous composition comprising an adjuvant and a latex polymer, the adjuvant comprising (A) an amide compound, and (B) a non-ionic surfactant;
wherein the amide compound is represented by the general formula:
R₁—(C═O)—N(R₂)(R₃) (I)
wherein R₁ represents a C₄-C₂₂, saturated or unsaturated, linear or branched, aliphatic hydrocarbon group,
R₂ and R₃ represent a hydrogen, or a C₁-C₄, saturated or unsaturated, linear or branched, aliphatic hydrocarbon group;
the non-ionic surfactant has an HLB value in the range of from 13 to 18.

2. The aqueous composition according to claim 1, wherein the latex polymer is derived from at least one acrylic monomer selected from the group consisting of acrylic acid, acrylic acid esters, methacrylic acid, and methacrylic acid esters.

3. The aqueous composition according to claim 1 or 2, wherein the aqueous composition further comprises a pigment.

4. The aqueous composition according to any one of claims 1 to 3, wherein the amide compound is represented by the general formula:
R₁—(C═O)—N(R₂)(R₃) (II)
wherein R₁ represents a C₄-C₂₂, saturated or unsaturated, linear or branched, aliphatic hydrocarbon group;
R₂ and R₃ are methyl.

5. The aqueous composition according to any one of claims 1 to 4, wherein the weight ratio of (A)/(B) is in the range of from 2:3 to 19:1.

6. The aqueous composition according to any one of claims 1 to 5, wherein the non-ionic surfactant is a compound represented by the general formula:
R₄—(OCH₂CH₂)ₙ—OH (III)
wherein R₄ is a C₈-C₁₄ alkyl;
n is an integer of from 5 to 100.

7. The aqueous composition according to any one of claims 1 to 6, wherein the amide compound is represented by the general formula:
R₁—(C═O)—N(R₂)(R₃) (II)
wherein R₁ represents a C₄-C₂₂, saturated or unsaturated, linear or branched, aliphatic hydrocarbon group;
R₂ and R₃ are methyl;
the non-ionic surfactant is a compound represented by the general formula:
R₄—(OCH₂CH₂)ₙ—OH (III)
wherein R₄ is a C₈-C₁₄ alkyl;
n is an integer of from 5 to 100.

8. The aqueous composition according to any one of claims 1 to 7, wherein the amide compound is represented by the general formula:
R₁—(C═O)—N(R₂)(R₃) (II)
wherein R₁ represents a C₄-C₂₂, saturated or unsaturated, linear or branched, aliphatic hydrocarbon group;
R₂ and R₃ are methyl;
the non-ionic surfactant is a compound represented by the general formula:
R₄—(OCH₂CH₂)ₙ—OH (III)
wherein R₄ is a C₁₁-C₁₄ alkyl;
n is an integer of from 8 to 40.

9. The aqueous composition according to any one of claims 1 to 8, wherein the amide compound is represented by the general formula:
R₁—(C═O)—N(R₂)(R₃) (II)
wherein R₁ represents a C₆-C₁₂, saturated or unsaturated, linear or branched, aliphatic hydrocarbon group;
R₂ and R₃ are methyl;
the non-ionic surfactant is a compound represented by the general formula:
R₄—(OCH₂CH₂)ₙ—OH (III)
wherein R₄ is a C₁₁-C₁₄ alkyl;
n is an integer of from 8 to 40.

10. The aqueous composition according to any one of claims 1 to 9, wherein the aqueous composition further comprises one or more additional surfactants selected from anionic surfactants, cationic surfactants and amphoteric surfactants.

11. The aqueous composition according to claim 10, wherein the one or more additional surfactants are sulfate ester salts.

12. A process for preparing the aqueous composition according to any one of claims 1 to 11, wherein it comprises at least a step to mix (A) an amide compound, and (B) a non-ionic surfactant.

13. The aqueous composition according to any one of claims 1 to 12, wherein the total weight of the amide compound and the non-ionic surfactant which are present in the aqueous composition is in the range of from 0.01% to 5% based on the total weight of the aqueous composition.

14. A process for preparing an aqueous composition comprising the step of mixing the adjuvant according to any one of claims 1 to 10 with water.
